(19) United States
(12) Patent Application Publication
(10) Pub. No.: US 2026/0175500 A1
(43) Pub. Date: Jun. 25, 2026

(54) MOLDING MANAGEMENT SYSTEM

(71) Applicant: SEIKO EPSON CORPORATION, Tokyo (JP)

(72) Inventors: Tomohiro TAKIZAWA, Matsumoto-shi (JP); Tatsuo AKASAKA, Azumino-shi (JP)

(73) Assignee: SEIKO EPSON CORPORATION, Tokyo (JP)

(21) Appl. No.: 19/428,350

(22) Filed: Dec. 22, 2025

(30) Foreign Application Priority Data
Dec. 24, 2024 (JP) 2024-227102

(51) Int. Cl. B29C 45/76; B29C 45/17

(52) U.S. Cl. CPC B29C 45/76; B29C 45/1774; B29C 2045/7606

(57) ABSTRACT

A molding management system for managing production of a product in a production process including an injection molding process of the product performed by an injection molding apparatus, the molding management system includes an information processing device, the information processing device acquires data including a plurality of types of information related to injection molding from the injection molding apparatus, and displays, on a display unit in response to an operation that is received, a display pattern reception image for receiving, as a display pattern, information indicating a combination of information to be displayed in an information display image for displaying at least a part of the plurality of types of information, the display pattern reception image is capable of receiving two or more of the display patterns for each user, and the two or more display patterns indicate combinations of information different from each other.

The present application is based on, and claims priority from JP Application Serial Number 2024-227102, filed December 24, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product performed by an injection molding apparatus, has been studied and developed.

Here, a technique is known in which a combination of two or more pieces of information, acquired from an injection molding apparatus, in an image for displaying at least a part of the two or more pieces of information, can be set for each user (see JP-A-2016-030348).

JP-A-2016-030348 is an example of the related art.

Here, in the technique described in JP-A-2016-030348, the combination of two or more pieces of information that can be set for each user is only one combination. However, there are various types of data acquired from the injection molding apparatus. Then, the combination of data required by the user is often different for each use. Therefore, it may be difficult for the technique to improve convenience for the user.

### SUMMARY

An aspect of the disclosure is a molding management system for managing production of a product in a production process including an injection molding process of the product performed by an injection molding apparatus, the molding management system including: an information processing device communicably connected to a terminal device, in which the information processing device acquires data including a plurality of types of information related to injection molding from the injection molding apparatus, and displays, on a display unit in response to an operation that is received, a display pattern reception image for receiving, as a display pattern, information indicating a combination of information to be displayed in an information display image for displaying at least a part of the plurality of types of information, the display pattern reception image is capable of receiving two or more of the display patterns for each user, and the two or more display patterns indicate combinations of information different from each other.

### BRIEF DESCRIPTION OF THE DRAWINGS

FIG. 1 is a diagram showing an example of a configuration of a molding management system 1.

FIG. 2 is a diagram showing an example of a display pattern reception image P1.

FIG. 3 is a diagram showing an example of an accordion menu AM1 in an expanded state.

FIG. 4 is a diagram showing an example of an accordion menu AM2 in an expanded state.

FIG. 5 is a diagram showing an example of an accordion menu AM3 in an expanded state.

FIG. 6 is a diagram showing an example of an information display image P0 in which information of a combination indicated by a certain display pattern received via the display pattern reception image P1 is displayed.

FIG. 7 is a diagram showing an example of a display pattern setting image P2.

FIG. 8 is a diagram showing an example of the display pattern setting image P2 when a recommended-display-pattern list is displayed in a region R9.

FIG. 9 is a diagram showing another example of the display pattern setting image P2.

FIG. 10 is a diagram showing an example of a hardware configuration of an information processing device X.

FIG. 11 is a diagram showing an example of a functional configuration of the information processing device X.

FIG. 12 is a diagram showing an example of a flow of processing performed by the information processing device X in response to a received operation.

### DESCRIPTION OF EMBODIMENTS

### Embodiment

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product performed by an injection molding apparatus. The molding management system includes an information processing device. The information processing device is communicably connected to a terminal device. The information processing device acquires data including a plurality of types of information related to injection molding from the injection molding apparatus. Then, the information processing device displays, on a display unit in response to an operation that is received, a display pattern reception image for receiving, as a display pattern, information indicating a combination of information to be displayed in an information display image for displaying at least a part of the plurality of types of information. The display pattern reception image is capable of receiving two or more of the display patterns for each user. The two or more display patterns indicate combinations of information different from each other. Accordingly, the molding management system can easily change the combination of information to be displayed in the information display image to a combination desired by the user according to use.

In the following description, a configuration of the molding management system according to such an embodiment and processing performed by a server provided in the molding management system will be described in detail. In the present embodiment, when a certain piece of information X1 and another piece of information X2 are different information, a type of the information X1 is treated as different from a type of the information X2. That is, in the present embodiment, a certain piece of data including a plurality of pieces of different information means the data including a plurality of types of information.

### Configuration of Molding Management System

Hereinafter, the configuration of the molding management system according to the embodiment will be described by taking a molding management system 1 as an example.

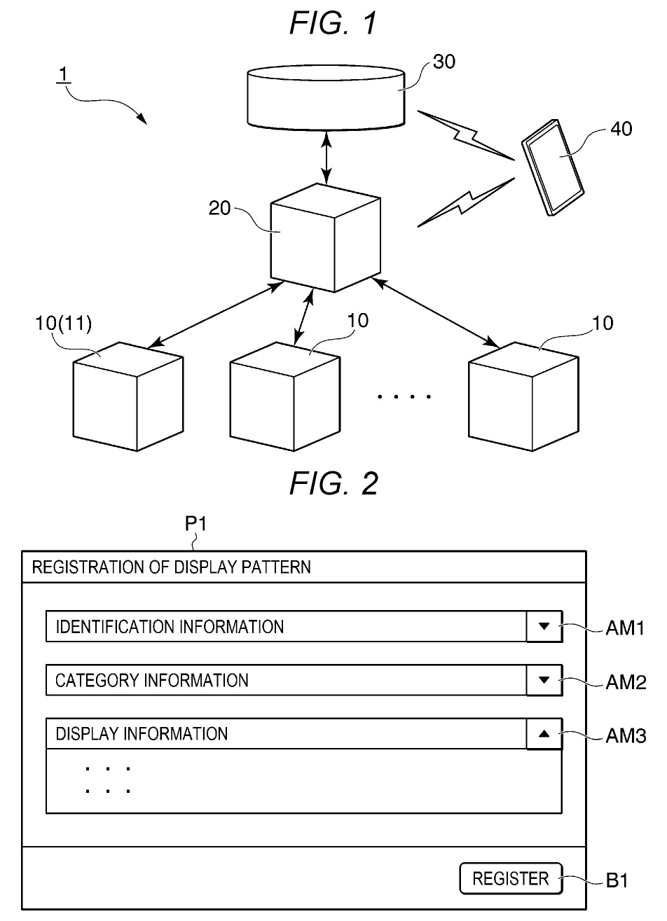

FIG. 1 is a diagram showing an example of a configuration of the molding management system 1.

The molding management system 1 is a type of manufacturing execution system (MES). For example, the molding management system 1 includes one or more managed devices 10, an information processing device 20, and a server 30. The molding management system 1 may not include a part or all of the one or more managed devices 10. The molding management system 1 may include the server 30 without including the information processing device 20. Further, the molding management system 1 may include the information processing device 20 without including the server 30. In the molding management system 1, the information processing device 20 may be configured integrally with the server 30. Hereinafter, as an example, a case in which the molding management system 1 includes a plurality of managed devices 10 as the one or more managed devices 10 will be described. Hereinafter, as an example, a case in which the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same reference numeral. However, a part or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of such an injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Hereinafter, the injection molding apparatus that performs the injection molding of a product using resin such as plastic is simply referred to as an injection molding apparatus. At least one injection molding apparatus in the plurality of managed devices 10 may be a device that performs injection molding using a material other than resin and metal. In addition to the injection molding apparatus, the plurality of managed devices 10 include, for example, peripheral equipment of the injection molding apparatus. Examples of the peripheral equipment of the injection molding apparatus include, but are not limited to, a material supply device, a conveying device, a cleaning device, and a sintering device. Here, the material supply device is a device that supplies a material used for injection molding of a product by the injection molding apparatus to the injection molding apparatus. The cleaning device is a device that conveys a product injection-molded by the injection molding apparatus. The cleaning device is a device that cleans a product injection-molded by the injection molding apparatus. The sintering device is a device that sinters a product after being cleaned by the cleaning device.

The molding management system 1 manages production of a product in a production process including an injection molding process of the product performed by the injection molding apparatus in the plurality of managed devices 10. Here, the injection molding apparatus in the plurality of managed devices 10 may have any configuration as long as the configuration is capable of producing a product by injection molding. Hereinafter, for convenience of description, a process in which the injection molding apparatus performs injection molding of a product once is referred to as a cycle. Hereinafter, for convenience of description, a cavity in a mold attached to the injection molding apparatus is referred to as a cavity. That is, the injection molding apparatus performs injection molding of a product by injecting a material into the cavity in the mold attached to the injection molding apparatus and applying a pressure to the material in the cavity.

Here, one or more injection molding apparatuses in the plurality of managed devices 10 each include an extrusion unit that extrudes a material used for injection molding of a product into the cavity in the mold attached to the injection molding apparatus in the injection molding process. The extrusion unit is, for example, a screw that moves a position in a cylinder back and forth by rotating in the cylinder. Instead of the screw, the extrusion unit may be a member that moves the position in the cylinder back and forth by a hydraulic pressure, a linear actuator, or the like. The material is extruded from an injection port of the cylinder toward the cavity in the mold in response to advance of the extrusion unit in the cylinder. Hereinafter, for convenience of description, the extrusion unit in the injection molding apparatus is referred to as a screw.

Further, one or more detection units are attached to the one or more injection molding apparatuses in the plurality of managed devices 10. The one or more detection units detect a quantity controlled by the injection molding apparatus in each cycle. The quantity controlled by the injection molding apparatus in each cycle is, for example, a part or all of a screw position, an injection speed that is a speed at which the material is injected into the cavity in the mold by the screw, a screw rotation speed, an injection holding pressure that is a pressure in the mold held by the screw, and a temperature in the mold, but is not limited thereto. Hereinafter, for convenience of description, the quantity detected by each of the one or more detection units attached to each of the one or more injection molding apparatuses in the plurality of managed devices 10 is simply referred to as a detection quantity. A detection unit that detects a certain detection quantity among the one or more detection units attached to a certain injection molding apparatus is, for example, a sensor that detects the detection quantity, but is not limited thereto. The one or more detection units may include a detection unit that detects a quality of the product. This is because the quality of the product is also controlled by the injection molding apparatus in each cycle. In this case, the detection unit is, for example, a device that includes an imaging unit capable of imaging the product to detect the quality of the product, but is not limited thereto. In this case, for example, a quantity indicating the quality of the product detected by the detection unit is, for example, any of a plurality of predetermined values arranged in descending order of quality, but is not limited thereto.

The information processing device 20 acquires various data such as cycle data, injection molding condition data, and operation state history data from each of the one or more injection molding apparatuses in the plurality of managed devices 10. Hereinafter, in order to simplify the description, as an example, a case in which two types of data, including the cycle data and the injection molding condition data are acquired by the information processing device 20 from each of the one or more injection molding apparatuses will be described. The information processing device 20 independently acquires each of the two types of data. Therefore, in this example, timings at which these two types of data are acquired by the information processing device 20 are different from each other, except for a case in which the timings accidentally match each other, unless the timings are intentionally matched. Hereinafter, for convenience of description, these two types of data will be collectively referred to as injection molding-related data unless it is necessary to distinguish them from each other. The injection molding-related data is an example of data including a plurality of types of information related to the injection molding.

The information processing device 20 acquires the cycle data for each cycle from each of the one or more injection molding apparatuses in the plurality of managed devices 10. More specifically, the information processing device 20 acquires the cycle data from each of the one or more injection molding apparatuses every time each cycle ends. Hereinafter, for convenience of description, the cycle data acquired when a certain cycle ends is referred to as cycle data of the cycle. Hereinafter, for convenience of description, a cycle that ends when certain cycle data is acquired is referred to as a cycle of the cycle data.

The cycle data acquired from a certain injection molding apparatus in a certain cycle includes a plurality of types of information. Specifically, the cycle data includes one or more pieces of cycle-related information obtained in response to execution of the cycle by the injection molding apparatus, apparatus identification information for identifying the injection molding apparatus, and first date-and-time information indicating a date and time when the cycle data is acquired by the information processing device 20 from the injection molding apparatus. The apparatus identification information is, for example, an identifier (ID) for identifying the injection molding apparatus, and may be other information through which the injection molding apparatus can be identified, such as an Internet protocol (IP) address assigned to the injection molding apparatus. The first date-and-time information may be a time stamp or other information indicating the date and time. The cycle data may include other information in addition to the one or more pieces of cycle-related information, the apparatus identification information, and the first date-and-time information. Further, the apparatus identification information may be included in the cycle data as any piece of the one or more pieces of cycle-related information. Hereinafter, as an example, a case in which the apparatus identification information is included in the cycle data as any piece of the one or more pieces of cycle-related information will be described.

The one or more pieces of cycle-related information included in the cycle data acquired from a certain injection molding apparatus in a certain cycle include one or more pieces of detection quantity information in addition to the apparatus identification information for identifying the injection molding apparatus. Each of the one or more pieces of detection quantity information is information indicating a value of each detection quantity controlled by the injection molding apparatus. The detection quantity information indicating a value of a certain detection quantity includes time-series information indicating a time series of the detection quantity and feature value information indicating one or more types of feature values for the detection quantity. Here, the one or more types of feature values for the certain detection quantity are, for example, at least one of a minimum value, a maximum value, an average value, a variance, and a standard deviation of the detection quantity, a start value of a period in which the detection quantity is detected, and an end value of the period. That is, the one or more types of feature values are values indicating features of a waveform indicating a temporal change in the detection quantity. The one or more types of feature values may include another value obtained by performing statistical processing on the detection quantity, instead of a part or all of the feature values or in addition to all of the feature values. The feature value information may be contained in the detection quantity information in the injection molding apparatus or the information processing device 20. This is because the information processing device 20 can calculate the one or more types of feature values based on the time-series information. The detection quantity information may not include the time-series information as long as including the feature value information. Hereinafter, as an example, a case in which both the time-series information and the feature value information are included in the detection quantity information will be described.

The one or more pieces of cycle-related information included in the cycle data acquired from the certain injection molding apparatus in the certain cycle may include other information in addition to the apparatus identification information and one or more pieces of feature value information. The other information is, for example, a part or all of operation state information and product quantity information, but is not limited thereto. Here, the operation state information included in the cycle data as the cycle-related information is information indicating an operation state of the injection molding apparatus. The product quantity information included in the cycle data as the cycle-related information is information indicating the number of products injection-molded by the injection molding apparatus in the cycle.

The cycle data as described above can be distinguished by a combination of the apparatus identification information and the first date-and-time information. When there is only one injection molding apparatus coupled to the information processing device 20, the cycle data may not include the apparatus identification information. This is because, in this case, the cycle data can be distinguished simply by the first date-and-time information.

When a certain piece of cycle data is acquired, the information processing device 20 stores the acquired cycle data and outputs the acquired cycle data to the server 30. Accordingly, the information processing device 20 can also store the acquired cycle data in the server 30.

Further, the information processing device 20 acquires the injection molding condition data from each of the one or more injection molding apparatuses in the plurality of managed devices 10 every time an injection molding condition is set in the injection molding apparatus.

Here, the injection molding condition data acquired from a certain injection molding apparatus is information in which one or more pieces of injection molding condition information each indicating the injection molding condition set in the injection molding apparatus, the apparatus identification information for identifying the injection molding apparatus, and second date-and-time information indicating a date and time when the injection molding condition data is acquired by the information processing device 20 from the injection molding apparatus are associated with one another. The apparatus identification information is, for example, an ID for identifying the injection molding apparatus, but may be other information through which the injection molding apparatus can be identified, such as an IP address assigned to the injection molding apparatus. The second date-and-time information may be a time stamp or other information indicating the date and time. The injection molding condition data may include other information in addition to the one or more pieces of injection molding condition information, the apparatus identification information, and the second date-and-time information. The apparatus identification information may be included in the injection molding condition data as any piece of the one or more pieces of injection molding condition information. Hereinafter, as an example, a case in which the apparatus identification information is included in the injection molding condition data as any piece of the one or more pieces of injection molding condition information will be described.

The one or more pieces of injection molding condition information included in the injection molding condition data acquired from a certain injection molding apparatus include one or more pieces of target value information in addition to the apparatus identification information for identifying the injection molding apparatus. Each of the one or more pieces of target value information is information indicating one or more target values in the control for each detection quantity performed by the injection molding apparatus. Therefore, the target value information indicating one or more target values for a certain detection quantity is associated with the detection quantity. A method of associating the detection quantity with the target value information may be a known method or a method to be developed in the future. A reason why the one or more pieces of target value information are included in the injection molding condition data as the injection molding condition information is that, for each detection quantity in each cycle, the injection molding apparatus controls the detection quantity such that the value of the detection quantity matches the target value of the detection quantity. Here, a reason why there are one or more target values for each detection quantity is that there may be a plurality of target values as targets to which each detection quantity is to be brought close in the control performed by the injection molding apparatus in each cycle. For example, the injection speed, which is the speed at which the material is injected into the cavity in the mold by the screw, changes in a plurality of stages in the injection molding process in each cycle. In such a case, there are a plurality of target values for the detection quantity. The target value information for a certain detection quantity indicates each of the one or more target values for the detection quantity. Therefore, the injection molding condition data includes, as the injection molding condition information, the target value information of the same pieces as the number of detection units attached to the injection molding apparatus. Hereinafter, for convenience of description, each of the one or more target values for a certain detection quantity is referred to as a target value corresponding to the detection quantity. Therefore, hereinafter, for convenience of description, the detection quantity is referred to as a detection quantity corresponding to the one or more target values.

The one or more pieces of injection molding condition information included in the injection molding condition data acquired from a certain injection molding apparatus may include other information in addition to the apparatus identification information for identifying the injection molding apparatus and the one or more pieces of target value information. The other information is abnormality determination condition information associated with each target value set as the injection molding condition in the injection molding apparatus or the like, but is not limited thereto. Here, the abnormality determination condition information associated with a certain target value is information indicating an abnormality determination condition satisfied by a value of a detection quantity corresponding to the target value when no abnormality occurs in the value of the detection quantity in the control in which the injection molding apparatus causes the value of the detection quantity to match the target value. A method of associating the target value with the abnormality determination condition information may be a known method or a method to be developed in the future. The abnormality determination condition may be any condition as long as the condition is satisfied by the value of the detection quantity when no abnormality occurs in the value of the detection quantity in the control.

The injection molding condition data as described above can be distinguished by a combination of the apparatus identification information and the second date-and-time information. When there is only one injection molding apparatus coupled to the information processing device 20, the injection molding condition data may not include the apparatus identification information. This is because, in this case, each piece of injection molding condition data can be distinguished simply by the second date-and-time information.

When a certain piece of injection molding condition data is acquired, the information processing device 20 stores the acquired injection molding condition data and outputs the acquired injection molding condition data to the server 30. Accordingly, the information processing device 20 can also store the acquired injection molding condition data in the server 30. Here, the information processing device 20 associates the injection molding condition data indicating the injection molding conditions set in a certain injection molding apparatus in a certain cycle with the cycle data acquired from the injection molding apparatus in the cycle. Such an association method may be a known method or may be a method to be developed in the future. By such association, at least one piece of injection molding condition data is associated with each piece of cycle data. Hereinafter, as an example, a case in which one piece of injection molding condition data is associated with each piece of cycle data will be described.

In response to a request from the terminal device communicably connected to the information processing device 20, the information processing device 20 displays, on a display unit of the terminal device, various images based on the injection molding-related data stored in the information processing device 20. Here, the images are a graphical user interface (GUI), an icon, a window on an operating system (OS), and the like. Hereinafter, as an example, a case in which the information processing device 20 is communicably connected to the terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing certain processing in response to a received operation means the information processing device 20 performing the processing in response to an operation received from the terminal device 40 via the image displayed on the terminal device 40.

Examples of the information processing device 20 include, but are not limited to, a workstation, a desktop personal computer (PC), and a notebook PC. The information processing device 20 is communicably connected to each of the plurality of managed devices 10 by wired or wireless communication. Examples of a communication network that connects the information processing device 20 and the plurality of managed devices 10 include, but are not limited to, a Local Area Network (LAN) in a facility in which the plurality of managed devices 10 are installed. The communication network may be another communication network such as the Internet or a mobile communication network.

The server 30 stores the cycle data acquired by the information processing device 20. For example, when a certain piece of cycle data is acquired from the information processing device 20, the server 30 stores the acquired cycle data.

The server 30 stores the injection molding condition data acquired by the information processing device 20. For example, when a certain piece of injection molding condition data is acquired from the information processing device 20, the server 30 stores the acquired injection molding condition data.

In response to a request from a terminal device communicably connected to the server 30, the server 30 displays, on a display unit of the terminal device, various images based on the injection molding-related data stored in the server 30. Here, the images are the GUI, the icon, the window on the OS, and the like. Hereinafter, as an example, a case in which the server 30 is communicably connected to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via the image displayed on the terminal device 40 is simply referred to as the server 30 receiving an operation. That is, hereinafter, the server 30 performing certain processing in response to a received operation means the server 30 performing the processing in response to an operation received from the terminal device 40 via the image displayed on the terminal device 40.

As described above, in the molding management system 1, both the information processing device 20 and the server 30 display, in response to the received operation, various images based on the stored injection molding-related data on the display unit of the terminal device 40. Therefore, hereinafter, for convenience of description, the information processing device 20 and the server 30 are collectively referred to as an information processing device X unless it is necessary to distinguish the information processing device 20 and the server 30. Examples of the display unit include, but are not limited to, a display of the terminal device 40 and a display device communicably connected to the terminal device 40. Hereinafter, as an example, a case in which the display unit is the display of the terminal device 40 will be described. Hereinafter, for convenience of description, displaying a certain image on the display unit is referred to as displaying an image.

Here, the information processing device X can receive two or more display patterns for each user according to the received operation. The display pattern of a certain user is information stored in the information processing device X by the user, and is information indicating a combination of information to be displayed in an information display image P0 for displaying at least a part of the plurality of types of information included in the injection molding-related data. The information display image P0 will be described later in detail. When the display pattern of a certain user is received, the information processing device X receives an operation of the user logging into the information processing device X, thereby specifying the user who has logged into the information processing device X as a target user. Then, the information processing device X in a state where the target user logs in sets the received operation as an operation from the target user and displays a display pattern reception image P1 for receiving a display pattern of the target user in response to the operation from the target user. The display pattern reception image P1 is an image capable of receiving two or more display patterns for each user. In other words, the information processing device X can receive two or more display patterns of the target user in the display pattern reception image P1 in response to the operation from the target user. Of course, the information processing device X can receive only one display pattern of the target user in the display pattern reception image P1 in response to the operation from the target user. The two or more display patterns received by the display pattern reception image P1 as the display pattern of the target user indicate combinations of information different from each other.

FIG. 2 is a diagram showing an example of the display pattern reception image P1. In the example shown in FIG. 2, the display pattern reception image P1 includes three accordion menus including an accordion menu AM1 to an accordion menu AM3, and a button B1. Instead of a part or all of these or in addition to all of these, the display pattern reception image P1 may include another GUI capable of receiving the display pattern. In FIG. 2, each of the accordion menu AM1 and the accordion menu AM2 are in a collapsed state. Therefore, in FIG. 2, information or the like displayed when each of the accordion menu AM1 and the accordion menu AM2 is expanded is not shown. In FIG. 2, the accordion menu AM3 is in an expanded state. However, in FIG. 2, in order to simplify the drawing, information and the like displayed in the accordion menu AM3 in the expanded state are indicated by "...".

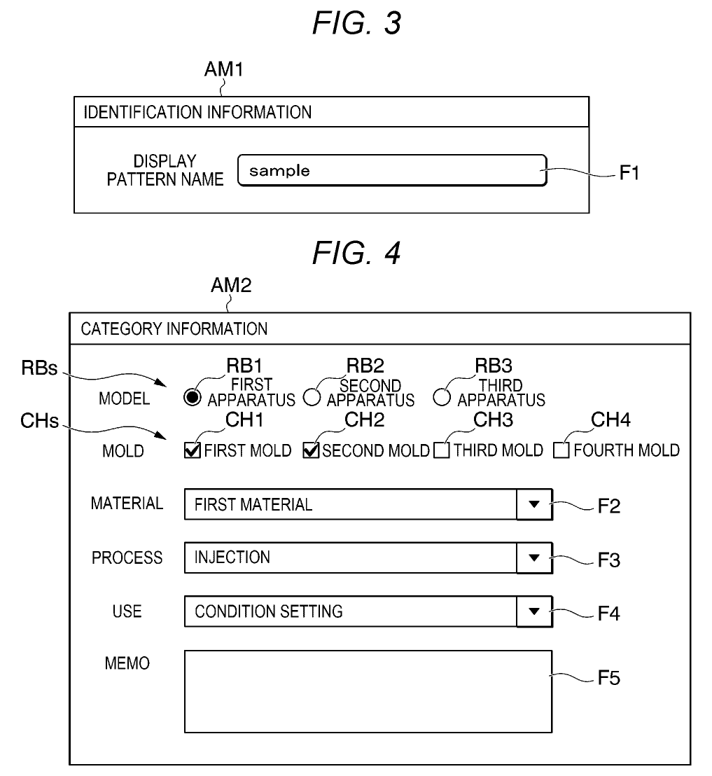

Every time a selection operation is received, the accordion menu AM1 is switched between the collapsed state and the expanded state. The accordion menu AM1 is an accordion menu that displays a GUI for receiving display pattern identification information when being in the expanded state. In the present embodiment, the selection operation means a click, a tap, or the like, but is not limited thereto. The display pattern identification information may be any information as long as being information for identifying the display pattern. For example, the display pattern identification information is information indicating a name that is not overlapped in the information processing device X as a name associated with the display pattern, but is not limited thereto. FIG. 3 is a diagram showing an example of the accordion menu AM1 in the expanded state. In the example shown in FIG. 3, an input field F1 is displayed in the accordion menu AM1 in the expanded state. The accordion menu AM1 in the expanded state may be configured to display another GUI in addition to the input field F1.

The input field F1 is a field for inputting the display pattern identification information desired by the target user. Here, in the example shown in FIG. 3, "sample" is input to the input field F1 as an example of the display pattern identification information. When the display pattern identification information is input to the input field F1, the information processing device X specifies the display pattern identification information input to the input field F1 as the display pattern identification information associated with the display pattern received via the display pattern reception image P1. The display pattern identification information may be input to the input field F1 by selecting the display pattern identification information recommended by the information processing device X from a pull-down menu or may be directly input using an input device such as a keyboard. The display pattern identification information recommended by the information processing device X may be any display pattern identification information as long as the display pattern identification information does not overlap in the information processing device X. A method of recommending the display pattern identification information by the information processing device X may be a known method or a method to be developed in the future.

Every time a selection operation is received, the accordion menu AM2 is switched between the collapsed state and the expanded state. The accordion menu AM2 is an accordion menu that displays a GUI for receiving category information when being in the expanded state. The category information is information indicating a category to which the display pattern received via the display pattern reception image P1 belongs. In the present embodiment, the category is represented by one or more pieces of information related to the injection molding. In this case, the category information is information including one or more pieces of information related to the injection molding. For example, the category information is information including at least one of the apparatus identification information for identifying the injection molding apparatus, mold identification information for identifying the mold attached to the injection molding apparatus, material identification information for identifying the material used for molding a product, process identification information for identifying a process included in the cycle of the injection molding, display pattern use information indicating use of the display pattern received via the display pattern reception image P1, and additional information indicating information to be added for the display pattern. In this case, the category is represented by the at least one piece of the above information. The category information may include other information, instead of a part or all of these pieces of information or in addition to all these pieces of information. FIG. 4 is a diagram showing an example of the accordion menu AM2 in the expanded state.

In the example shown in FIG. 4, a radio button group RBs, a check box group CHs, an input field F2, an input field F3, an input field F4, and an input field F5 are displayed in the accordion menu AM2 in the expanded state. Instead of a part or all of these GUIs or in addition to all of these GUIs, the accordion menu AM2 in the expanded state may include another GUI capable of receiving the category information.

The radio button group RBs includes radio buttons respectively corresponding to one or more pieces of apparatus identification information stored in the information processing device X. In the example shown in FIG. 4, the radio button group RBs includes three radio buttons including a radio button RB1, a radio button RB2, and a radio button RB3. The radio button RB1 is a radio button associated with "first apparatus" that is apparatus identification information for identifying a first apparatus that is one of the injection molding apparatuses from which the information processing device X acquires the injection molding-related data. The radio button RB2 is a radio button associated with "second apparatus" that is apparatus identification information for identifying a second apparatus that is one of the injection molding apparatuses from which the information processing device X acquires the injection molding-related data. The radio button RB3 is a radio button associated with "third apparatus" that is apparatus identification information for identifying a third apparatus that is one of the injection molding apparatuses from which the information processing device X acquires the injection molding-related data. When a selection operation is performed on any of the radio buttons in the radio button group RBs, the information processing device X specifies the apparatus identification information associated with the radio button on which the selection operation is performed as the apparatus identification information to be included in the category information. When a selection operation is performed on a certain one of the radio buttons in the radio button group RBs, the information processing device X changes a display mode of the radio button to a display mode indicating that the apparatus identification information associated with the radio button is selected, and changes a display mode of each of other radio buttons excluding the radio button in the radio button group RBs to a display mode indicating that the apparatus identification information associated with the corresponding radio button is not selected. These two display modes may be any display mode as long as the two modes can be distinguished from each other. In this example, a display mode of the radio button RB1 is a display mode indicating that the apparatus identification information associated with the radio button RB1 is selected. Meanwhile, in this example, a display mode of the radio button RB2 is a display mode indicating that the apparatus identification information associated with the radio button RB2 is not selected. Further, in this example, a display mode of the radio button RB3 is a display mode indicating that the apparatus identification information associated with the radio button RB3 is not selected. The information processing device X may not include the apparatus identification information in the category information or may include null information as the apparatus identification information in the category information, when no selection operation is performed on all the radio buttons in the radio button group RBs.

The check box group CHs includes check boxes respectively corresponding to one or more pieces of mold identification information stored in the information processing device X. In the example shown in FIG. 4, the check box group CHs includes four check boxes including a check box CH1, a check box CH2, a check box CH3, and a check box CH4. The check box CH1 is a check box associated with "first mold" which is the mold identification information for identifying a first mold that is one of the molds attachable to the injection molding apparatus. The check box CH2 is a check box associated with "second mold" which is the mold identification information for identifying a second mold that is one of the molds attachable to the injection molding apparatus. The check box CH3 is a check box associated with "third mold" which is the mold identification information for identifying a third mold that is one of the molds attachable to the injection molding apparatus. The check box CH4 is a check box associated with "fourth mold" which is the mold identification information for identifying a fourth mold that is one of the molds attachable to the injection molding apparatus. When a selection operation is performed on a part or all of the check boxes in the check box group CHs, the information processing device X specifies the mold identification information associated with each of the check boxes on which the selection operation is performed as the mold identification information to be included in the category information. When a selection operation is performed on a certain one of the check boxes in the check box group CHs, the information processing device X changes a display mode of the check box to a display mode indicating that the mold identification information associated with the check box is selected, and changes a display mode of each of other check boxes excluding the check box in the check box group CHs to a display mode indicating that the mold identification information associated with the corresponding check box is not selected. These two display modes may be any display mode as long as the two modes can be distinguished from each other. In this example, a display mode of the check box CH1 is a display mode indicating that the mold identification information associated with the check box CH1 is selected. In this example, a display mode of the check box CH2 is a display mode indicating that the mold identification information associated with the check box CH2 is selected. Meanwhile, in this example, a display mode of the check box CH3 is a display mode indicating that the mold identification information associated with the check box CH3 is not selected. Further, in this example, a display mode of the check box CH4 is also a display mode indicating that the mold identification information associated with the check box CH4 is not selected. The information processing device X may not include the mold identification information in the category information or may include null information as the mold identification information in the category information, when no selection operation is performed on all the check boxes in the check box group CHs.

The input field F2 is a field for inputting the material identification information desired by the target user. Here, in the example shown in FIG. 4, "first material" is input to the input field F2 as an example of the material identification information. When the material identification information is input to the input field F2, the information processing device X specifies the material identification information input to the input field F2 as the material identification information to be included in the category information. The material identification information may be input to the input field F2 by selecting the material identification information from a pull-down menu or may be directly input using an input device such as a keyboard. When nothing is input to the input field F2, the information processing device X may not include the material identification information in the category information, or may include null information as the material identification information in the category information.

The input field F3 is a field for inputting the process identification information desired by the target user. Here, in the example shown in FIG. 4, "injection" is input to the input field F3 as an example of the process identification information. When the process identification information is input to the input field F3, the information processing device X specifies the process identification information input to the input field F3 as the process identification information to be included in the category information. The process identification information may be input to the input field F3 by selecting the process identification information from a pull-down menu or may be directly input using an input device such as a keyboard. When nothing is input to the input field F3, the information processing device X may not include the process identification information in the category information, or may include null information as the process identification information in the category information.

The input field F4 is a field for inputting the display pattern use information desired by the target user. Here, in the example shown in FIG. 4, "condition setting" is input to the input field F4 as an example of the display pattern use information. When the display pattern use information is input to the input field F4, the information processing device X specifies the display pattern use information input to the input field F4 as the display pattern use information to be included in the category information. The display pattern use information may be input to the input field F4 by selecting the display pattern use information from a pull-down menu or may be directly input using an input device such as a keyboard. When nothing is input to the input field F4, the information processing device X may not include the display pattern use information in the category information, or may include null information as the display pattern use information in the category information.

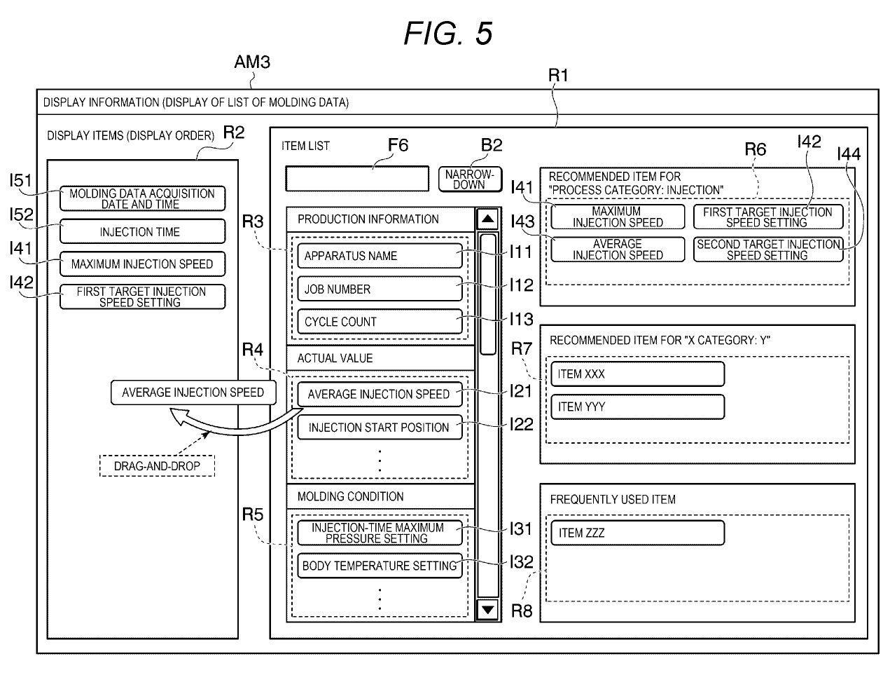

The input field F5 is a field for inputting, as the additional information, a character string desired by the target user. Here, in an example shown in FIG. 5, nothing is input to the input field F5. When the additional information is input to the input field F5, the information processing device X specifies the additional information input to the input field F5 as the additional information to be included in the category information. The additional information may be directly input to the input field F5 using an input device such as a keyboard, but may be input by another method such as voice input. When nothing is input to the input field F5, the information processing device X may not include the additional information in the category information, or may include null information as the additional information in the category information. The additional information may be interpreted as memo information indicating a memo desired by the target user.

Every time a selection operation is received, the accordion menu AM3 is switched between the collapsed state and the expanded state. The accordion menu AM3 is an accordion menu that displays a GUI for receiving the display pattern when being in the expanded state. FIG. 5 is a diagram showing an example of the accordion menu AM3 in the expanded state.

In the example shown in FIG. 5, a first region R1 and a second region R2 are displayed in the accordion menu AM3 in the expanded state. In the accordion menu AM3 in the expanded state, instead of one or both of these GUIs, or in addition to both of these GUIs, another GUI capable of receiving the display pattern may be displayed.

The first region R1 is a region for displaying a GUI for receiving an operation of selecting one or more types of information desired by the target user among the plurality of types of information included in the injection molding-related data. In the example shown in FIG. 5, the first region R1 is a region for displaying, as selectable icons, a list of icons respectively associated with the plurality of types of information. More specifically, in this example, in the first region R1, six regions including a region R3 to a region R8, an input field F6, and a button B2 are displayed.

The region R3 is a region for displaying icons associated with one or more types of information classified into a first information category among the plurality of types of information included in the injection molding-related data. Each of the icons is an icon that can be selected in response to an operation from the target user. Here, the first information category is one of predetermined categories for classifying the plurality of types of information. In the example shown in FIG. 5, the first information category is information related to production of a product. In FIG. 5, the first information category is indicated by "production information". In this example, three icons including an icon I11 to an icon I13 are displayed in the region R3.

The icon I11 is an icon associated with apparatus name information which is one piece of the information classified into the first information category. Here, the apparatus name information is information indicating a name of the injection molding apparatus. In FIG. 5, the apparatus name information is indicated by "apparatus name".

The icon I12 is an icon associated with job number information which is one piece of the information classified into the first information category. Here, the job number information is information indicating a number for identifying a job to be executed by the injection molding apparatus. In FIG. 5, the job number information is indicated by "job number".

The icon I13 is an icon associated with the cycle count information which is one piece of the information classified into the first information category. Here, the cycle count information is information indicating the number of cycles executed by the injection molding apparatus. In FIG. 5, the cycle count information is indicated by "cycle count".

For example, the information processing device X specifies the information associated with the first information category information indicating the first information category among the plurality of types of information included in the injection molding-related data, and displays the icons indicating the specified information in the region R3. Further, the information processing device X specifies information associated with the first information category information based on, for example, first association information stored in advance. The first association information is information indicating each of one or more types of information associated with the first information category information. The first association information may be stored by the target user or may be stored in the information processing device X in advance. Further, the first information category may be information related to other matters instead of the information related to the production of a product.

The region R4 is a region for displaying icons associated with one or more types of information classified into a second information category among the plurality of types of information included in the injection molding-related data. Each of the icons is an icon that can be selected in response to an operation from the target user. Here, the second information category is one of the predetermined categories for classifying the plurality of types of information. In the example shown in FIG. 5, the second information category is information related to the detection quantity. In FIG. 5, the second information category is indicated by "actual value". In this example, two icons including an icon I21 and an icon I22 are displayed in the region R4.

The icon I21 is an icon associated with average injection speed information which is one piece of the information classified into the second information category. Here, the average injection speed information is information indicating an average value of the speed at which the injection molding apparatus injects the material into the mold. In FIG. 5, the average injection speed information is indicated by "average injection speed".

The icon I22 is an icon associated with injection start position information which is one piece of the information classified into the second information category. Here, the injection start position information is information indicating a position of the screw when the injection molding apparatus starts injecting the material into the mold. In FIG. 5, the injection start position information is indicated by "injection start position".

For example, the information processing device X specifies the information associated with the second information category information indicating the second information category among the plurality of types of information included in the injection molding-related data, and displays the icons indicating the specified information in the region R4. Further, the information processing device X specifies information associated with the second information category information based on, for example, second association information stored in advance. The second association information is information indicating each of one or more types of information associated with the second information category information. The second association information may be stored by the target user or may be stored in the information processing device X in advance. Further, the second information category may be information related to other matters instead of the information related to the detection quantity.

The region R5 is a region for displaying icons associated with one or more types of information classified into a third information category among the plurality of types of information included in the injection molding-related data. Each of the icons is an icon that can be selected in response to an operation from the target user. Here, the third information category is one of the predetermined categories for classifying the plurality of types of information. In the example shown in FIG. 5, the third information category is information related to the injection molding condition set in the injection molding apparatus. In FIG. 5, the third information category is indicated by "molding condition". In this example, two icons including an icon I31 and an icon I32, are displayed in the region R5.

The icon I31 is an icon associated with injection-time target maximum pressure information which is one piece of the information classified into the third information category. Here, the injection-time target maximum pressure information is information indicating a value serving as a target for matching a maximum pressure in the mold under control on the maximum pressure performed by the injection molding apparatus. In FIG. 5, the injection-time target maximum pressure information is indicated by "injection-time maximum pressure setting".

The icon I32 is an icon associated with target body temperature information which is one piece of the information classified into the third information category. Here, the target body temperature information is information indicating a value serving as a target for matching a temperature of the mold under control on the temperature performed by the injection molding apparatus. In FIG. 5, the target body temperature information is indicated by "body temperature setting".

For example, the information processing device X specifies the information associated with the third information category information indicating the third information category among the plurality of types of information included in the injection molding-related data, and displays the icons indicating the specified information in the region R5. Further, the information processing device X specifies information associated with the third information category information based on, for example, third association information stored in advance. The third association information is information indicating each of one or more types of information associated with the third information category information. The third association information may be stored by the target user or may be stored in the information processing device X in advance. Further, the third information category may be information related to other matters instead of the information related to the detection quantity.

The region R6 is a region for displaying icons associated with one or more types of information classified into a fourth information category among the plurality of types of information included in the injection molding-related data. Each of the icons is an icon that can be selected in response to an operation from the target user. Here, the fourth information category is one of the predetermined categories for classifying the plurality of types of information according to the use of the display pattern received via the display pattern reception image P1. In the example shown in FIG. 5, the fourth information category is information recommended to be displayed in the information display image P0 in management of the injection molding process. In FIG. 5, the fourth information category is indicated by "recommended item for 'process category: injection'". In this example, four icons including an icon I41 to an icon I44 are displayed in the region R6.

The icon I41 is an icon associated with maximum injection speed information which is one piece of the information classified into the fourth information category. Here, the maximum injection speed information is information indicating a maximum value of the speed at which the injection molding apparatus injects the material into the mold. In FIG. 5, the maximum injection speed information is indicated by "maximum injection speed".

The icon I42 is an icon associated with first target injection speed information which is one piece of the information classified into the fourth information category. Here, the first target injection speed information is a value serving as a target of the speed at which the injection molding apparatus injects the material into the mold in a first half of the injection molding process. In FIG. 5, the first target injection speed information is indicated by "first target injection speed setting".

The icon I43 is an icon associated with the average injection speed information which is one piece of the information classified into the fourth information category. Here, the average injection speed information is information indicating an average value of the speed at which the injection molding apparatus injects the material into the mold. In FIG. 5, the average injection speed information is indicated by "average injection speed".

The icon I44 is an icon associated with second target injection speed information which is one piece of the information classified into the fourth information category. Here, the second target injection speed information is a value serving as a target of the speed at which the injection molding apparatus injects the material into the mold in a latter half of the injection molding process. In FIG. 5, the second target injection speed information is indicated by "second target injection speed setting".

For example, the information processing device X specifies the information classified into the fourth information category among the plurality of types of information included in the injection molding-related data based on a history of the category information associated with the display pattern received via the display pattern reception image P1. Then, the information processing device X displays the icons indicating respective pieces of the specified information in the region R6. The specification may be performed by estimation using a model of machine learning, or may be performed by estimation using another method. The fourth information category may be information recommended to be displayed in the information display image P0 in management other than the injection molding process.

Each of the region R7 and the region R8 is a region for displaying an icon associated with information classified into a category determined in advance for classifying the plurality of types of information according to another use of the display pattern received via the display pattern reception image P1, instead of the fourth information category. Since configurations of the region R7 and the region R8 are substantially the same as the configuration of the region R6, a detailed description thereof will be omitted. In the example shown in FIG. 5, the region R8 is a region for displaying an icon associated with information highly frequently included in the display pattern received via the display pattern reception image P1.

The input field F6 is a field for inputting a search key for searching for an icon to be displayed in the first region R1. Here, in an example shown in FIG. 5, nothing is input to the input field F6. When a character string is input to the input field F6 and a selection operation is performed on the button B2, the information processing device X displays, in the first region R1, icons associated with information searched for using the character string input to the input field F6 as a search key. A method of searching for information using a search key may be a known method or may be a method to be developed in the future.

The button B2 is a button for receiving an operation of causing the information processing device X to search for information using the search key input to the input field F6.

The second region R2 is a region for displaying icons associated with one or more types of information selected in the first region R1. For example, the second region R2 is a region for displaying an icon selected by a drag-and-drop in the first region R1. The icon in the first region R1 may be selected by another method instead of the drag-and-drop. In the example shown in FIG. 5, four icons including an icon I51, an icon I52, the icon I41, and the icon I42 are displayed in the second region R2. This indicates that these four icons are selected from the first region R1 by the target user.

Here, the icon I51 is an icon associated with the first date-and-time information described above. In FIG. 5, the first date-and-time information is indicated by "molding data acquisition date and time". The icon I52 is an icon associated with injection time information. An injection time is information indicating a time during which the injection molding apparatus injects the material into the mold in the injection molding process. In FIG. 5, the injection time information is indicated by "injection time".

When one or more icons are displayed in the second region R2, the information processing device X specifies, as the display pattern, information indicating a combination of information associated with the one or more icons displayed in the second region R2.

Return to FIG. 2. The button B1 is a button for receiving an operation of completing the reception of the display pattern via the display pattern reception image P1. When a selection operation is performed on the button B1, the information processing device X stores the display pattern identification information specified in the accordion menu AM1 and the category information specified in the accordion menu AM2 in association with the display pattern specified in the accordion menu AM3. Accordingly, the information processing device X can easily receive the display pattern. Further, the association of the category information with the display pattern can prevent the management of the display pattern from becoming complicated, and is useful. The information processing device X may be configured to, when the display pattern identification information is not specified in the accordion menu AM1 at the time of storing the display pattern, not associate the display pattern identification information with the display pattern, or associate the null information with the display pattern as the display pattern identification information. Further, the information processing device X may be configured to, when the category information is not specified in the accordion menu AM2 at the time of storing the display pattern, not associate the category information with the display pattern, or associate the null information with the display pattern as the category information.

The information processing device X can receive a different display pattern every time the display pattern reception image P1 is displayed. Therefore, the information processing device X can receive two or more display patterns for each user. Accordingly, the information processing device X can easily change the combination of information to be displayed in the information display image P0 to a combination desired by the user according to the use. For example, when a first display pattern and a second display pattern different from the first display pattern are received via the display pattern reception image P1 as display patterns of a certain user, the information processing device X stores each of the received first display pattern and second display pattern in association with user identification information for identifying the user. Accordingly, the information processing device X can distinguish which of the two or more display patterns stored for the users belongs to which user. The display pattern reception image P1 may be configured to receive two or more display patterns by displaying the display pattern reception image P1 once without repeating displaying the display pattern reception image P1. In this case, the display pattern reception image P1 includes GUIs for receiving two or more display patterns, such as a GUI for receiving a first display pattern, a GUI for receiving a second display pattern, a GUI for receiving a third display pattern, and the like.

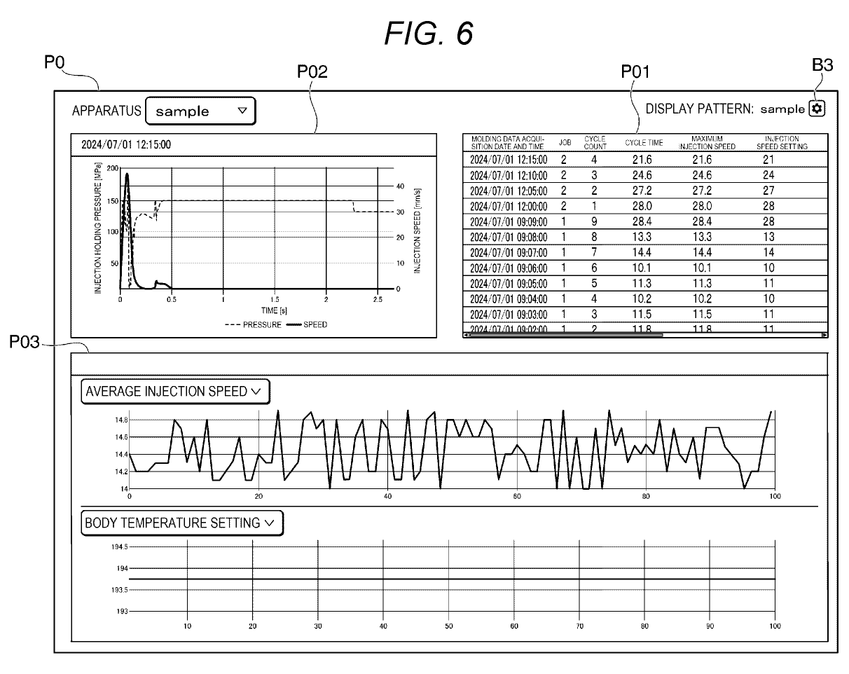

Here, FIG. 6 is a diagram showing an example of the information display image P0 in which information of a combination indicated by a certain display pattern received via the display pattern reception image P1 is displayed. The information display image P0 includes three images including an image P01, an image P02, and an image P03, and a button B3.

The image P01 is an example of an image for displaying a list of the first date-and-time information, the job number information, the cycle count information, the cycle time information, the maximum injection speed information, and the first target injection speed information among the information included in a combination indicated by a certain display pattern received via the display pattern reception image P1. In the example shown in FIG. 6, in the image P01, the first date-and-time information, the job number information, the cycle count information, the cycle time information, the maximum injection speed information, and the first target injection speed information are displayed for each piece of cycle data. A method of generating the image P01 based on the display pattern may be any method. Further, a configuration of the image P01 shown in FIG. 6 is merely an example, and may be another configuration in which each of the first date-and-time information, the job number information, the cycle count information, the cycle time information, the maximum injection speed information, and the first target injection speed information is displayed in another display mode. The cycle time information is an example of information included in the cycle data as the cycle-related information. The cycle time information included in a certain piece of cycle data is information indicating a time required to execute a cycle in the cycle data. Further, the image P01 may be an image in which a list of all pieces of information included in the injection molding-related data is displayed.

The image P02 is an example of an image for displaying a waveform indicating a temporal change in the injection speed indicated by the injection speed information and a waveform indicating a temporal change in the injection holding pressure indicated by the injection holding pressure information, among the information included in the combination indicated by the certain display pattern received via the display pattern reception image P1. The injection speed information is information indicating an injection speed at which the injection molding apparatus injects the material into the mold in the injection molding process in the cycle. Further, the injection holding pressure information is information indicating a pressure in the mold when the injection molding apparatus injects the material into the mold in the injection molding process in the cycle. A horizontal axis of a graph displayed in the image P02 indicates an elapsed time in the cycle. A vertical axis on a left side of the graph indicates the injection holding pressure. A vertical axis on a right side of the graph indicates the injection speed. A method of generating the image P02 based on the display pattern may be any method. Further, a configuration of the image P02 shown in FIG. 6 is merely an example, and may be another configuration in which each of the injection speed information and the injection holding pressure information is displayed in another display mode.

The image P03 is an example of an image for displaying a trend graph for a value of the average injection speed indicated by the average injection speed information and a trend graph for a value indicated by the target body temperature information among the information included in the combination indicated by the certain display pattern received via the display pattern reception image P1. A horizontal axis of an upper trend graph in the two trend graphs displayed in the image P03 indicates each of the cycles executed in order. A vertical axis of the trend graph represents the average injection speed. A horizontal axis of a lower trend graph in the two trend graphs displayed in the image P03 indicates each of the cycles executed in order. A vertical axis of the trend graph indicates the value indicated by the target body temperature information. A method of generating the image P03 based on the display pattern may be any method. Further, a configuration of the image P03 shown in FIG. 6 is merely an example, and may be another configuration in which each of the average injection speed information and the target body temperature information is displayed in another display mode.

The information display image P0 may include, instead of a part or all of the images P01 to P03, or in addition to all of the images P01 to P03, another image for displaying at least a part of the information included in the combination indicated by the certain display pattern received via the display pattern reception image P1.

The button B3 is a button for receiving an operation of displaying a display pattern setting image P2 for receiving an operation of designating a display pattern indicating a combination to be used as the combination of information to be displayed in the information display image P0. When a selection operation is performed on the button B3, the information processing device X displays the display pattern setting image P2.

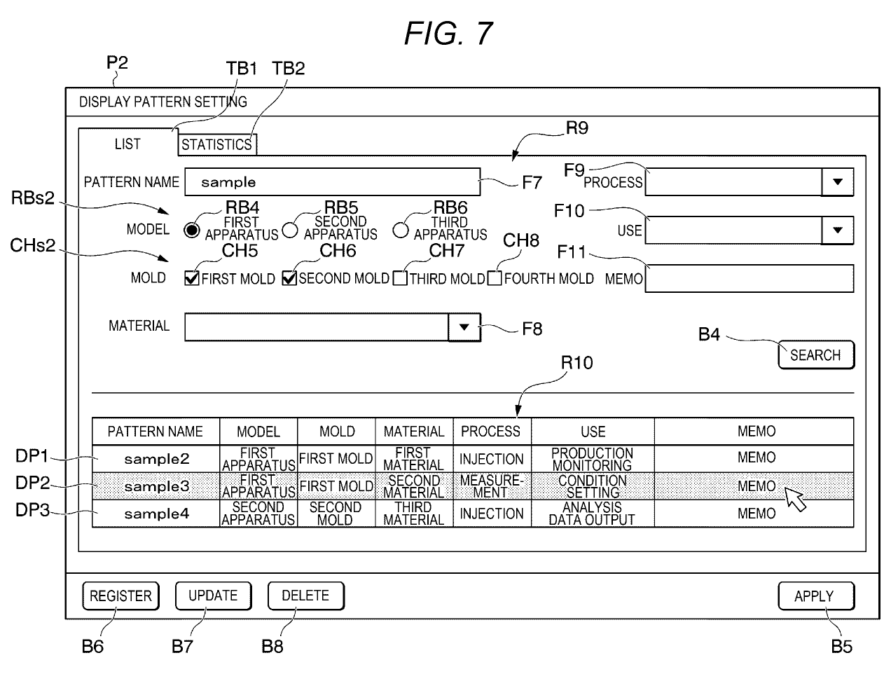

Here, FIG. 7 is a diagram showing an example of the display pattern setting image P2. In the display pattern setting image P2, a region R9, a tab TB1, a tab TB2, a button B5, a button B6, a button B7, a button B8, and various GUIs displayed in the region R9 in response to a selection operation on the tab TB1 are displayed. Hereinafter, for convenience of description, the various GUIs will be referred to as search-related GUIs. In the present embodiment, the search-related GUI includes an input field F7, a radio button group RBs2, a check box group CHs2, an input field F8, an input field F9, an input field F10, an input field F11, a button B4, and a region R10.

The tab TB1 is a GUI related to a search for the display pattern, that is, a GUI for receiving an operation of displaying a search-related GUI in the region R9. When a selection operation is performed on the tab TB1, the information processing device X displays the search-related GUI in the region R9.

The search-related GUI is a GUI for receiving, as a search key, at least a part of the information associated with the display pattern as the category information and receiving an operation of causing the information processing device X to search for a display pattern corresponding to the received search key. Each of five input fields including the input field F7 to the input field F11, the radio button group RBs2, and the check box group CHs2 is an example of a GUI for receiving, as a search key, at least a part of the information associated with the display pattern as the category information. The button B4 is an example of a GUI for receiving an operation of causing the information processing device X to execute a search corresponding to the search key received via the GUI. Further, the region R10 is a region for displaying, as a search result of such a display pattern, a list of information associated with one or more display patterns. Hereinafter, for convenience of description, the list displayed in the region R10 will be referred to as a search result information list.

The input field F7 is a field for inputting desired display pattern identification information that the target user wants to use as a search key. Here, in the example shown in FIG. 7, "sample" is input to the input field F7 as an example of the display pattern identification information. When the display pattern identification information is input to the input field F7, the information processing device X specifies the display pattern identification information input to the input field F7 as one of the search keys used to search for the display pattern. The display pattern identification information may be input to the input field F7 by selection from a pull-down menu, or may be directly input using an input device such as a keyboard. When nothing is input to the input field F7, the information processing device X does not specify the display pattern identification information as one of the search keys.

The radio button group RBs2 includes radio buttons respectively corresponding to one or more pieces of apparatus identification information stored in the information processing device X. In the example shown in FIG. 7, the radio button group RBs2 includes three radio buttons including a radio button RB4, a radio button RB5, and a radio button RB6. The radio button RB4 is a radio button associated with "first apparatus" which is the apparatus identification information for identifying the first apparatus described above. The radio button RB5 is a radio button associated with "second apparatus" which is the apparatus identification information for identifying the second apparatus described above. The radio button RB6 is a radio button associated with "third apparatus" which is the apparatus identification information for identifying the third apparatus described above. When a selection operation is performed on any of the radio buttons in the radio button group RBs2, the information processing device X specifies the apparatus identification information associated with the radio button on which the selection operation is performed as one of the search keys used to search for the display pattern. When a selection operation is performed on a certain one of the radio buttons in the radio button group RBs2, the information processing device X changes a display mode of the radio button to a display mode indicating that the apparatus identification information associated with the radio button is selected, and changes a display mode of each of other radio buttons excluding the radio button in the radio button group RBs2 to a display mode indicating that the apparatus identification information associated with the corresponding radio button is not selected. These two display modes may be any display mode as long as the two modes can be distinguished from each other. In this example, a display mode of the radio button RB4 is a display mode indicating that the apparatus identification information associated with the radio button RB4 is selected. Meanwhile, in this example, a display mode of the radio button RB5 is a display mode indicating that the apparatus identification information associated with the radio button RB5 is not selected. Further, in this example, a display mode of the radio button RB6 is a display mode indicating that the apparatus identification information associated with the radio button RB6 is not selected. Further, when no selection operation is performed on all the radio buttons in the radio button group RBs2, the information processing device X does not specify the apparatus identification information as one of the search keys.

The check box group CHs2 includes check boxes respectively corresponding to one or more pieces of mold identification information stored in the information processing device X. In the example shown in FIG. 7, the check box group CHs2 includes four check boxes including a check box CH5, a check box CH6, a check box CH7, and a check box CH8. The check box CH5 is a check box associated with "first mold" which is the mold identification information for identifying the first mold described above. The check box CH6 is a check box associated with "second mold" which is the mold identification information for identifying the second mold described above. The check box CH7 is a check box associated with "third mold" which is the mold identification information for identifying the third mold described above. The check box CH8 is a check box associated with "fourth mold" which is the mold identification information for identifying the fourth mold described above. When a selection operation is performed on a part or all of the check boxes in the check box group CHs2, the information processing device X specifies the mold identification information associated with each of the check boxes on which the selection operation is performed as one of the search keys used to search for the display pattern. When a selection operation is performed on a certain one of the check boxes in the check box group CHs2, the information processing device X changes a display mode of the check box to a display mode indicating that the mold identification information associated with the check box is selected, and changes a display mode of each of other check boxes excluding the check box in the check box group CHs2 to a display mode indicating that the mold identification information associated with the corresponding check box is not selected. These two display modes may be any display mode as long as they can be distinguished from each other. In this example, a display mode of the check box CH5 is a display mode indicating that the mold identification information associated with the check box CH5 is selected. In this example, a display mode of the check box CH6 is a display mode indicating that the mold identification information associated with the check box CH6 is selected. Meanwhile, in this example, a display mode of the check box CH7 is a display mode indicating that the mold identification information associated with the check box CH7 is not selected. Further, in this example, a display mode of the check box CH8 is also a display mode indicating that the mold identification information associated with the check box CH8 is not selected. Further, when no selection operation is performed on all the check boxes in the check box group CHs2, the information processing device X does not specify the mold identification information as one of the search keys.

The input field F8 is a field for inputting desired material identification information that the target user wants to use as a search key. Here, in the example shown in FIG. 7, nothing is input to the input field F8. When the material identification information is input to the input field F8, the information processing device X specifies the material identification information input to the input field F8 as one of the search keys used to search for the display pattern. The material identification information may be input to the input field F8 by selecting the material identification information from a pull-down menu or may be directly input using an input device such as a keyboard. When nothing is input to the input field F8, the information processing device X does not specify the material identification information as one of the search keys.

The input field F9 is a field for inputting desired process identification information that the target user wants to use as a search key. Here, in the example shown in FIG. 7, nothing is input to the input field F9. When the process identification information is input to the input field F9, the information processing device X specifies the process identification information input to the input field F9 as one of the search keys used to search for the display pattern. The process identification information may be input to the input field F9 by selecting the process identification information from a pull-down menu or may be directly input using an input device such as a keyboard. When nothing is input to the input field F9, the information processing device X does not specify the process identification information as one of the search keys.

The input field F10 is a field for inputting desired display pattern use information that the target user wants to use as a search key. Here, in the example shown in FIG. 7, nothing is input to the input field F10. When the display pattern use information is input to the input field F10, the information processing device X specifies the display pattern use information input to the input field F10 as one of the search keys used to search for the display pattern. The display pattern use information may be input to the input field F10 by selecting the display pattern use information from a pull-down menu or may be directly input using an input device such as a keyboard. When nothing is input to the input field F10, the information processing device X does not specify the display pattern use information as one of the search keys.

The input field F11 is a field for inputting desired additional information that the target user wants to use as a search key. Here, in the example shown in FIG. 7, nothing is input to the input field F11. When the additional information is input to the input field F11, the information processing device X specifies the additional information input to the input field F11 as one of the search keys used to search for the display pattern. The additional information may be directly input to the input field F11 using an input device such as a keyboard, but may be input by another method such as voice input. When nothing is input to the input field F11, the information processing device X does not use the additional information as one of the search keys.

The button B4 is a button for receiving an operation of causing the information processing device X to search for the display pattern using one or more search keys specified through a part or all of the input field F7 to the input field F11, the radio button group RBs2, and the check box group CHs2. When a selection operation is performed on the button B4, the information processing device X searches for the display pattern using the specified one or more search keys, and displays the search result information list as a search result in the region R10.

As described above, the region R10 is a region for displaying the search result list information. In the example shown in FIG. 7, a list of information associated with three display patterns obtained as a result of searching for the display pattern using four pieces of information, that is, the display pattern identification information "sample", the apparatus identification information "first apparatus", the mold identification information "first mold", and the mold identification information "second mold" as search keys is displayed in the region R10 as the search result list information. For example, information DP1 is a combination of the display pattern identification information and the category information in a display pattern associated with a first one among three display patterns. In this example, the display pattern identification information is "sample 2". Further, in this example, the category information is information including "first apparatus" as the apparatus identification information, "first mold" as the mold identification information, "first material" as the material identification information, "injection" as the process identification information, "production monitoring" as the display pattern use information, and "memo" as the additional information. For example, information DP2 is a combination of the display pattern identification information and the category information in a display pattern associated with a second one among the three display patterns. In this example, the display pattern identification information is "sample 3". In this example, the category information is information including "first apparatus" as the apparatus identification information, "first mold" as the mold identification information, "second material" as the material identification information, "measurement" as the process identification information, "condition setting" as the display pattern use information, and "memo" as the additional information. For example, information DP3 is a combination of the display pattern identification information and the category information in a display pattern associated with a third one among the three display patterns. In this example, the display pattern identification information is "sample 4". Further, in this example, the category information is information including "second apparatus" as the apparatus identification information, "second mold" as the mold identification information, "third material" as the material identification information, "injection" as the process identification information, "analysis data output" as the display pattern use information, and "memo" as the additional information.

In the example shown in FIG. 7, the target user can select a desired display pattern by selecting any of the information DP1 to the information DP3 included in the search result list information displayed in the region R10. For example, when a selection operation is performed on the information DP1, the information processing device X selects a display pattern associated with the information DP1. The display pattern selected in this manner is a display pattern designated as a display pattern indicating a combination to be used as a combination of information to be displayed in the information display image P0.

The button B5 is a button for receiving an operation of confirming that a display pattern selected by the target user in the region R10 is designated as the display pattern indicating the combination to be used as the combination of information to be displayed in the information display image P0. When a selection operation is performed on the button B5, the information processing device X designates the display pattern selected by the target user in the region R10 as the display pattern indicating the combination to be used as the combination of information to be displayed in the information display image P0. In other words, in this case, the information processing device X sets the display pattern selected by the target user in the region R10 as the combination of information to be displayed in the information display image P0. Accordingly, when the target user displays the information display image P0 again, the information of the combination indicated by the display pattern selected by the target user in the region R10 is displayed in the information display image P0. As a result, the information processing device X can cause the user to use a display pattern corresponding to a situation. In other words, in this case, the information processing device X displays, in the information display image P0, the information of the combination indicated by the display pattern selected by the target user in the region R10. The information processing device X may be configured to designate, by another method, the display pattern indicating the combination to be used as the combination of information to be displayed in the information display image P0.

The button B6 is a button for receiving an operation of deleting the display of the display pattern setting image P2 and displaying the display pattern reception image P1. When receiving a selection operation on the button B6, the information processing device X deletes the display of the display pattern setting image P2 and displays the display pattern reception image P1. Accordingly, when the desired display pattern is not displayed in the display pattern setting image P2, the target user can quickly store the desired display pattern in the information processing device X.

The button B7 is a button for receiving an operation of deleting the display of the display pattern setting image P2 and displaying the display pattern reception image P1 for updating the display pattern selected by the target user in the region R10. The update may be referred to as editing of the display pattern. When a selection operation is performed on the button B7, the information processing device X deletes the display of the display pattern setting image P2 and displays the display pattern reception image P1. However, in this case, the information processing device X displays the display pattern setting image P2 in which the display pattern identification information and the category information associated with the display pattern have already been input. In this case, the information processing device X displays the display pattern reception image P1 in which icons associated with the respective pieces of information of the combination indicated by the display pattern are displayed in the second region R2. Accordingly, when it is desired to update the display pattern displayed in the display pattern setting image P2, the target user can cause the information processing device X to quickly update the desired display pattern.

The button B8 is a button for receiving an operation of deleting the display pattern selected by the target user in the region R10 from a storage area of the information processing device X. When a selection operation on the button B8 is received, the information processing device X deletes the display pattern and the display pattern identification information and the category information associated with the display pattern from the storage area.

The tab TB2 is a GUI for receiving an operation of displaying, in the region R9, a list of display patterns recommended by the information processing device X for each use of the display patterns. Hereinafter, for convenience of description, the list of display patterns is referred to as a recommended-display-pattern list. When a selection operation is performed on the tab TB2, the information processing device X displays the recommended-display-pattern list in the region R9.

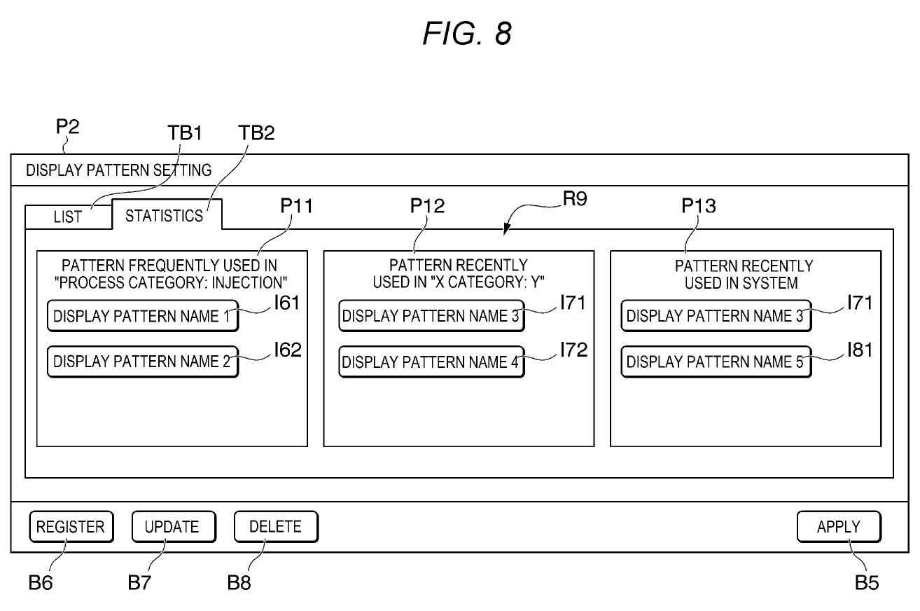

FIG. 8 is a diagram showing an example of the display pattern setting image P2 when the recommended-display-pattern list is displayed in the region R9. In the example shown in FIG. 8, the recommended-display-pattern list is displayed in the region R9. More specifically, in this example, the region R9 includes three images including an image P11, an image P12, and an image P13. The region R9 may include another image for displaying the recommended-display-pattern list instead of a part or all of the three images or in addition to the three images.

The image P11 is an image for displaying, as the recommended-display-pattern list, icons associated with one or more display patterns each indicating a combination of information recommended to be displayed in the information display image P0 in the management of the injection molding process. In the example shown in FIG. 8, two icons including an icon I61 and an icon I62 are displayed as such icons in the image P11. Here, in this example, the display pattern identification information for identifying a display pattern associated with the icon I61 is displayed on the icon I61. The display pattern identification information is "display pattern name 1". In this example, the display pattern identification information for identifying a display pattern associated with the icon I62 is displayed on the icon I62. The display pattern identification information is "display pattern name 2".

The image P12 is an image for setting display patterns recently used in "X category: Y" as one or more display patterns each indicating a combination of information recommended to be displayed in the information display image P0 as the recommended-display-pattern list, and displaying icons respectively associated with the one or more display patterns. In the example shown in FIG. 8, two icons including an icon I71 and an icon I72 are displayed as such icons in the image P12. Here, in this example, the display pattern identification information for identifying a display pattern associated with the icon I71 is displayed on the icon I71. The display pattern identification information is "display pattern name 3". In this example, the display pattern identification information for identifying a display pattern associated with the icon I72 is displayed on the icon I72. The display pattern identification information is "display pattern name 4".

The image P13 is an image for setting display patterns recently used in the information processing device X as one or more display patterns each indicating a combination of information recommended to be displayed in the information display image P0 as the recommended-display-pattern list, and displaying icons respectively associated with the one or more display patterns. In the example shown in FIG. 8, two icons including an icon I71 and an icon I81 are displayed as such icons in the image P13. Here, in this example, the display pattern identification information for identifying a display pattern associated with the icon I81 is displayed on the icon I81. The display pattern identification information is "display pattern name 5".

In this way, by displaying the recommended-display-pattern list in the region R9, the target user can easily and efficiently manage the cycle by using the display pattern used in the past even if the target user is not accustomed to the management of the cycle. That is, the information processing device X can improve convenience for the user. This also means that the user can use the display pattern corresponding to the situation, which is useful.

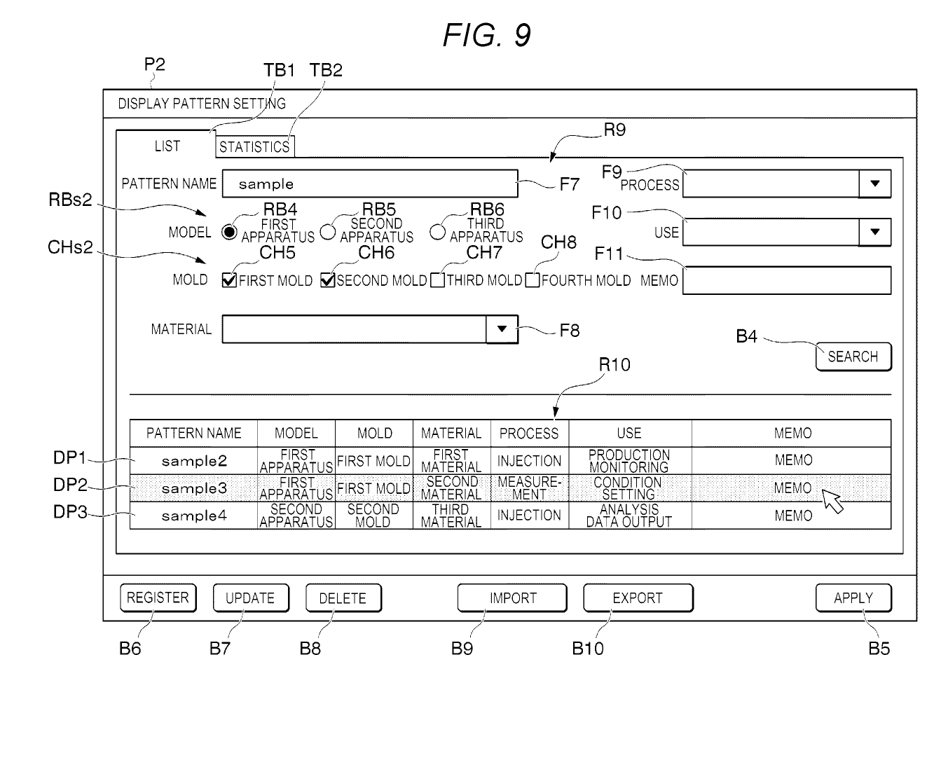

As shown in FIG. 9, the display pattern setting image P2 may include two buttons, a button B9 and a button B10. FIG. 9 is a diagram showing another example of the display pattern setting image P2.

The button B9 is a button for receiving an operation of importing, as the display pattern of the target user, a display pattern designated by the target user. When a selection operation on the button B9 is received, the information processing device X displays an image for receiving an operation of designating a display pattern to be imported, and imports, when a display pattern is designated via the image, the designated display pattern. That is, in this case, the information processing device X stores the designated display pattern in the storage area. Accordingly, even if a PC used as the information processing device X is replaced, the information processing device X can make it possible for the target user to easily use the desired display pattern. This means that the setting of the display pattern can be shared among a plurality of systems, a plurality of workers, and the like, and is useful because the work can be leveled. The display pattern to be imported may be associated with the display pattern identification information and the category information, or may not be associated with any one or both of the display pattern identification information and the category information. The button B9 is an example of an import operation reception image.

The button B10 is a button for receiving an operation of exporting the display pattern designated from all the display patterns stored in the information processing device X. When a selection operation on the button B10 is received, the information processing device X displays an image for receiving an operation of designating a display pattern to be exported, and exports, when a display pattern is designated via the image, the designated display pattern in a predetermined format. Examples of the predetermined format include, but are not limited to, Comma Separated Values (CSV), JavaScript Object Notation (JSON), and Extensible Markup Language (XML). Accordingly, even when the target user uses another device having the same function as the information processing device X, the information processing device X can make it possible for the target user to easily use the desired display pattern. This means that the setting of the display pattern can be shared among a plurality of systems, a plurality of workers, similar to importing the display pattern, and the like, and is useful because the work can be leveled. The display pattern to be exported may be associated with the display pattern identification information and the category information, or may not be associated with any one or both of the display pattern identification information and the category information.

### Hardware Configuration of Information Processing Device X

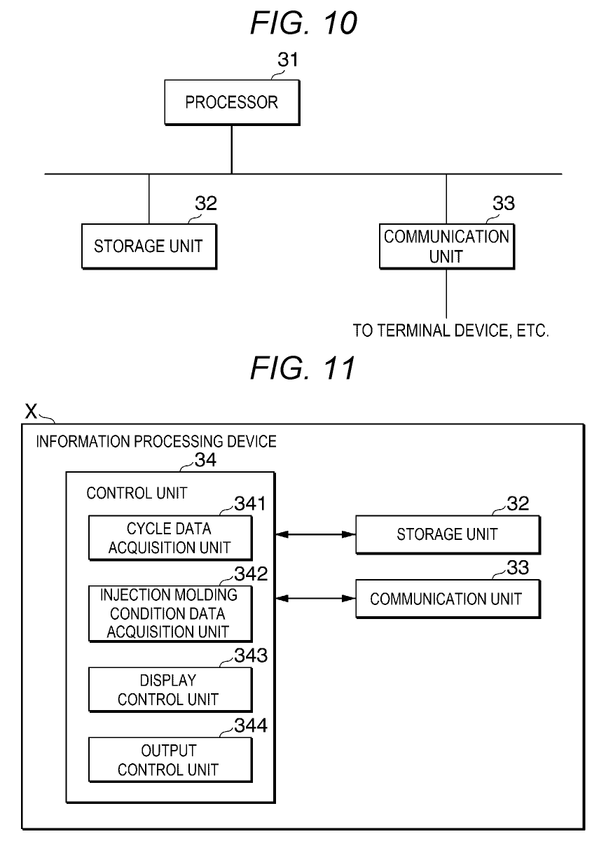

Here, the information processing device 20 and the server 30 may have the same hardware configuration or may have different hardware configurations. Hereinafter, as an example, a case in which the information processing device 20 and the server 30 have the same hardware configuration will be described. In other words, in one example, the information processing device X has a hardware configuration as shown in FIG. 10. FIG. 10 is a diagram showing an example of the hardware configuration of the information processing device X.

The information processing device X includes, for example, a processor 31, a storage unit 32, and a communication unit 33. These component elements are communicably connected to one another via a bus. The information processing device X communicates with other devices via the communication unit 33. For example, when the information processing device X is the information processing device 20, the other devices are the injection molding apparatus, the server 30, the terminal device 40, and the like. For example, when the information processing device X is the server 30, the other devices are the information processing device 20, the terminal device 40, and the like.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device X, the storage unit 32 may be an external storage device connected to a digital input and output port such as a universal serial bus (USB). The storage unit 32 stores various types of information, various images, and various programs to be processed by the information processing device X. That is, the various types of information stored in the information processing device X are stored in the storage unit 32.

The communication unit 33 is a communication device including, for example, a digital input and output port such as a USB, an Ethernet (registered trademark) port, and an antenna for wireless communication.

### Functional Configuration of Information Processing Device X

Here, the information processing device 20 and the server 30 may have the same functional configuration or may have different functional configurations. Hereinafter, as an example, a case in which the information processing device 20 and the server 30 have the same functional configuration will be described. In other words, in this example, the information processing device X has a functional configuration as shown in FIG. 11. FIG. 11 is a diagram showing an example of the functional configuration of the information processing device X.

The information processing device X includes the storage unit 32, the communication unit 33, and a control unit 34.

The control unit 34 controls the entire information processing device X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large scale integration (LSI) or an application specific integrated circuit (ASIC).

The cycle data acquisition unit 341 acquires the cycle data for each cycle of each injection molding apparatus from a device communicably connected to the information processing device X. Examples of the device include the injection molding apparatus and the information processing device 20.

The injection molding condition data acquisition unit 342 acquires the injection molding condition data from a device communicably connected to the information processing device X every time the injection molding condition is set in each injection molding apparatus. Examples of the device include the injection molding apparatus and the information processing device 20.

The display control unit 343 generates various images in response to the received operation. For example, the display control unit 343 generates the display pattern reception image P1 and the like. The display control unit 343 transmits the generated images to the terminal device 40 and displays the images on the terminal device 40.

The output control unit 344 outputs various types of data to another device in response to the received operation.

### Processing Performed by Information Processing Device X in Response to Received Operation

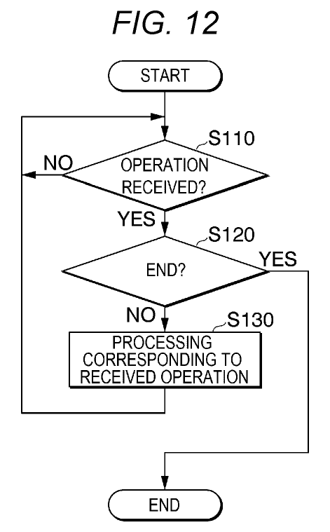

Referring to FIG. 12, processing performed by the information processing device X in response to each operation described above will be described. FIG. 12 is a diagram showing an example of a flow of the processing performed by the information processing device X in response to a received operation. Hereinafter, as an example, a case will be described in which the information processing device X is in a state in which various operations from the user can be received via the terminal device 40 at a timing before processing in step S110 shown in FIG. 12 is performed. Hereinafter, as an example, a case in which a plurality of pieces of cycle data and a plurality of pieces of injection molding condition data are already stored in the information processing device X at the timing will be described.

The control unit 34 waits until an operation is received via the terminal device 40 (step S110). In FIG. 12, the processing in step S110 is indicated by "operation received?".

When it is determined that the operation has been received via the terminal device 40 (step S110: YES), the control unit 34 determines whether the received operation is an operation for ending the processing in the flowchart shown in FIG. 12 (step S120). The determination processing may be performed by the control unit 34 in step S120 by a known method or by a method to be developed in the future. In FIG. 12, the processing in step S120 is indicated by "end?".

When it is determined that the operation received in step S110 is an operation for ending the processing in the flowchart shown in FIG. 12 (step S120: YES), for example, the control unit 34 ends the processing in the flowchart shown in FIG. 12.

On the other hand, when it is determined that the operation received in step S110 is not an operation for ending the processing in the flowchart shown in FIG. 12 (step S120: NO), the control unit 34 performs processing corresponding to the received operation (step S130). The processing includes various types of processing described as the processing performed by the information processing device X in the present embodiment. Here, since the processing performed by the control unit 34 in step S130 is already described with reference to FIGS. 2 to 9, a detailed description of the processing will be omitted.

After the processing in step S130 is performed, the control unit 34 transitions to step S110 and waits again until an operation is received via the terminal device 40.

By the processing as described above, the information processing device X acquires the injection molding-related data including a plurality of types of information related to the injection molding from the injection molding apparatus, and displays, in response to a received operation, the display pattern reception image P1 for receiving, as the display pattern, information indicating the combination of information to be displayed in the information display image P0 for displaying at least a part of the plurality of types of information. Further, the display pattern reception image P1 can receive two or more display patterns for each user. Accordingly, the information processing device X can easily change a combination of information to be displayed in the information display image P0 to a combination desired by the user according to the use.

The molding management system 1 described above may include the terminal device 40. The molding management system 1 described above may include an injection molding apparatus such as the injection molding apparatus 11.

The contents described above may be combined in any manner.

### Appendix

A molding management system for managing production of a product in a production process including an injection molding process of the product performed by an injection molding apparatus, the molding management system including:

an information processing device communicably connected to a terminal device, in which

the information processing device

acquires data including a plurality of types of information related to injection molding from the injection molding apparatus, and

displays, on a display unit in response to an operation that is received, a display pattern reception image for receiving, as a display pattern, information indicating a combination of information to be displayed in an information display image for displaying at least a part of the plurality of types of information,

the display pattern reception image is capable of receiving two or more of the display patterns for each user, and

the two or more display patterns indicate combinations of information different from each other.

The molding management system according to 1, in which

when a first display pattern and a second display pattern different from the first display pattern are received as the display pattern of a first user via the display pattern reception image, the information processing device stores each of the received first display pattern and second display pattern in a storage unit in association with user identification information for identifying the first user.

The molding management system according to 1 or 2, in which

the display pattern reception image is an image capable of receiving the display pattern and category information indicating a category to which the display pattern belongs, and

when a first display pattern is received as the display pattern and first category information is received as the category information indicating the category to which the first display pattern belongs in the display pattern reception image, the information processing device stores the first display pattern associated with the received first category information in a storage unit.

The molding management system according to 3, in which

the category information is information including at least one of apparatus identification information for identifying the injection molding apparatus, mold identification information for identifying a mold attached to the injection molding apparatus, material identification information for identifying a material used for molding the product, process identification information for identifying a process included in a cycle of the injection molding, display pattern use information indicating use of the display pattern, and additional information indicating information to be added for the display pattern.

The molding management system according to any one of 1 to 4, in which

the display pattern reception image is an image capable of receiving the display pattern and display pattern identification information for identifying the display pattern, and

when a first display pattern is received as the display pattern and the display pattern identification information for identifying the first display pattern is received as first display pattern identification information in the display pattern reception image, the information processing device stores the first display pattern associated with the received first display pattern identification information in a storage unit.

The molding management system according to any one of 1 to 5, in which

the display pattern reception image is an image for displaying a list of icons respectively associated with the plurality of types of information as selectable icons, and

when a selection operation of selecting at least a part of the icons respectively associated with the plurality of types of information is received in the display pattern reception image, the information processing device receives, as the display pattern, information indicating a combination of information associated with one or more icons selected by the selection operation among the plurality of types of icons.

The molding management system according to any one of 1 to 6, in which

in response to an operation that is received, the information processing device displays a display pattern setting image for receiving an operation of designating, as a target display pattern from among all of the display patterns stored in a storage unit, the display pattern indicating a combination to be used as the combination of information to be displayed in the information display image.

The molding management system according to 7, in which

when an operation of designating the target display pattern is received via the display pattern setting image, the information processing device sets a combination indicated by the target display pattern designated by the received operation, as the combination of information to be displayed in the information display image.

The molding management system according to 7 or 8, in which

the display pattern setting image is an image including a use-specific recommended display pattern display image for displaying a list of one or more of the display patterns which are recommended to be used as the combination of information to be displayed in the information display image, for each use of the display pattern.

The molding management system according to any one of 7 to 9, in which

the display pattern setting image is an image including an export operation reception image for receiving an operation of exporting the display pattern designated from all of the display patterns stored in the storage unit, and an import operation reception image for receiving an operation of importing the display pattern.

The molding management system according to any one of 7 to 10, in which

when an operation of designating the target display pattern is received in the display pattern setting image, the information processing device deletes display of the display pattern setting image and displays, in the information display image, one or more types of information included in a combination indicated by the target display pattern.

The molding management system according to any one of 1 to 11, in which

when the display pattern indicating a combination to be used as the combination of information to be displayed in the information display image is designated as a target display pattern, the information processing device displays, in the information display image, one or more types of information included in a combination indicated by the target display pattern.

The molding management system according to any one of 1 to 12, in which

the plurality of types of information includes first detection quantity information indicating a first detection quantity controlled by the injection molding apparatus in a cycle of the injection molding and second detection quantity information indicating a second detection quantity controlled by the injection molding apparatus in the cycle, and

the information display image includes at least one of an image for displaying a list of at least a part of the data, an image for displaying a graph of a waveform indicating a temporal change in a value of the first detection quantity indicated by the first detection quantity information, and an image for displaying a trend graph for a value of the second detection quantity indicated by the second detection quantity information.

The molding management system according to any one of 1 to 13, further including:

the terminal device.

The molding management system according to any one of 1 to 14, further including:

the injection molding apparatus.

The embodiment of the present disclosure is described in detail above with reference to the drawings. However, a specific configuration is not limited to the embodiment and may be, for example, changed, replaced, or deleted without departing from the gist of the present disclosure.

A program for implementing a function of any component in the device described above may be recorded in a computer-readable recording medium and the program may be read and executed by a computer system. Here, the device is, for example, the injection molding apparatus 11, the information processing device 20, the server 30, or the terminal device 40. Here, the "computer system" referred to here includes an operating system (OS) and hardware such as peripheral devices. The "computer-readable recording medium" refers to a portable medium such as a flexible disc, a magneto-optical disc, a ROM, or a compact disk (CD) ROM or a storage device such as a hard disk built in the computer system. Further, the "computer-readable recording medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the "transmission medium" for transmitting the program refers to a medium having a function of transmitting information like a network such as the Internet or a communication line such as a telephone line.

The program may be a program for implementing a part of the functions described above. Further, the program may be a so-called differential file or differential program that can implement the functions described above in combination with a program already recorded in the computer system.

What is claimed is:

1. A molding management system for managing production of a product in a production process including an injection molding process of the product performed by an injection molding apparatus, the molding management system comprising:
an information processing device communicably connected to a terminal device, wherein
the information processing device
acquires data including a plurality of types of information related to injection molding from the injection molding apparatus, and
displays, on a display unit in response to an operation that is received, a display pattern reception image for receiving, as a display pattern, information indicating a combination of information to be displayed in an information display image for displaying at least a part of the plurality of types of information,
the display pattern reception image is capable of receiving two or more of the display patterns for each user, and
the two or more display patterns indicate combinations of information different from each other.

2. The molding management system according to claim 1, wherein
when a first display pattern and a second display pattern different from the first display pattern are received as the display pattern of a first user via the display pattern reception image, the information processing device stores each of the received first display pattern and second display pattern in a storage unit in association with user identification information for identifying the first user.

3. The molding management system according to claim 1, wherein
the display pattern reception image is an image capable of receiving the display pattern and category information indicating a category to which the display pattern belongs, and
when a first display pattern is received as the display pattern and first category information is received as the category information indicating the category to which the first display pattern belongs in the display pattern reception image, the information processing device stores the first display pattern associated with the received first category information in a storage unit.

4. The molding management system according to claim 3, wherein
the category information is information including at least one of apparatus identification information for identifying the injection molding apparatus, mold identification information for identifying a mold attached to the injection molding apparatus, material identification information for identifying a material used for molding the product, process identification information for identifying a process included in a cycle of the injection molding, display pattern use information indicating use of the display pattern, and additional information indicating information to be added for the display pattern.

5. The molding management system according to claim 1, wherein
the display pattern reception image is an image capable of receiving the display pattern and display pattern identification information for identifying the display pattern, and
when a first display pattern is received as the display pattern and the display pattern identification information for identifying the first display pattern is received as first display pattern identification information in the display pattern reception image, the information processing device stores the first display pattern associated with the received first display pattern identification information in a storage unit.

6. The molding management system according to claim 1, wherein
the display pattern reception image is an image for displaying a list of icons respectively associated with the plurality of types of information as selectable icons, and
when a selection operation of selecting at least a part of the icons respectively associated with the plurality of types of information is received in the display pattern reception image, the information processing device receives, as the display pattern, information indicating a combination of information associated with one or more icons selected by the selection operation among the plurality of types of icons.

7. The molding management system according to claim 1, wherein
in response to an operation that is received, the information processing device displays a display pattern setting image for receiving an operation of designating, as a target display pattern from among all of the display patterns stored in a storage unit, the display pattern indicating a combination to be used as the combination of information to be displayed in the information display image.

8. The molding management system according to claim 7, wherein
when an operation of designating the target display pattern is received via the display pattern setting image, the information processing device sets a combination indicated by the target display pattern designated by the received operation, as the combination of information to be displayed in the information display image.

9. The molding management system according to claim 7, wherein
the display pattern setting image is an image including a use-specific recommended display pattern display image for displaying a list of one or more of the display patterns which are recommended to be used as the combination of information to be displayed in the information display image, for each use of the display pattern.

10. The molding management system according to claim 7, wherein
the display pattern setting image is an image including an export operation reception image for receiving an operation of exporting the display pattern designated from all of the display patterns stored in the storage unit, and an import operation reception image for receiving an operation of importing the display pattern.

11. The molding management system according to claim 7, wherein
when an operation of designating the target display pattern is received in the display pattern setting image, the information processing device deletes display of the display pattern setting image and displays, in the information display image, one or more types of information included in a combination indicated by the target display pattern.

12. The molding management system according to claim 1, wherein
when the display pattern indicating a combination to be used as the combination of information to be displayed in the information display image is designated as a target display pattern, the information processing device displays, in the information display image, one or more types of information included in a combination indicated by the target display pattern.

13. The molding management system according to claim 1, wherein
the plurality of types of information includes first detection quantity information indicating a first detection quantity controlled by the injection molding apparatus in a cycle of the injection molding and second detection quantity information indicating a second detection quantity controlled by the injection molding apparatus in the cycle, and
the information display image includes at least one of an image for displaying a list of at least a part of the data, an image for displaying a graph of a waveform indicating a temporal change in a value of the first detection quantity indicated by the first detection quantity information, and an image for displaying a trend graph for a value of the second detection quantity indicated by the second detection quantity information.

14. The molding management system according to claim 1, further comprising:
the terminal device.

15. The molding management system according to claim 1, further comprising:
the injection molding apparatus.
